(19) United States
(12) Patent Application Publication
(10) Pub. No.: US 2007/0046490 A1
(43) Pub. Date: Mar. 1, 2007

(54) Vehicle speed control device

(76) Inventor: Irene Booth, Henderson, NV (US)

Correspondence Address: WEISS & MOY PC, 4204 NORTH BROWN AVENUE, SCOTTSDALE, AZ, 85251, US

(21) Appl. No.: 11/211,393

(22) Filed: Aug. 25, 2005

(51) Int. Cl. G08C 19/00; B60T 7/16

(52) U.S. Cl. 340/825.69; 180/167

(57) ABSTRACT

A vehicle speed control device for remotely controlling the speed of a vehicle has receiver device coupled to the vehicle that receives a speed control signal, A processor device is coupled to the receiver device and to a computer control system of the vehicle. The processor device receives the speed control signal from the receiver and sends a signal to the computer control system of the vehicle to control the speed of the vehicle.

### FIELD OF THE INVENTION

This invention relates generally to vehicle speed control devices and more specifically to a vehicle speed control device having a wireless receiver device and a processor device.

### BACKGROUND OF THE INVENTION

High-speed police pursuits present significant danger and complications to society. Often the police are forced to make a very difficult decision: to pursue a suspect and risk a possibly fatal accident, or to let the suspect go free. Although the presence of helicopters and police radios make it easier to track a suspect, significant danger still exists.

Attempts have been made to solve the problem, but existing devices do not provide adequate effectiveness. For example, spike strips—devices that an officer places on the road in front of a pursued vehicle—are not always satisfactory. A policeman stands to the side of the road and throws the spike-strip in front of the vehicle as it drives by. Often the suspect notices the officer deploying the spike-strip and then simply drives around the obstacle. In some horrific cases, suspects will see the officer who is about to deploy the spike-strips and will drive the vehicle at the officer. Some remote controlled spike-strips exist, but still present the difficulty of deploying the strip in the path of the suspect. Another device, a rocket-powered remote control car that deploys a high-voltage electric charge to the vehicle of the suspect is equally difficult to operate. As a last resort, police officers will often try to ram a suspect. This technique presents obvious dangers and difficulties.

Accordingly, there existed a need for a vehicle speed control device that would safely allow police officers to slow and stop a vehicle.

### SUMMARY OF THE INVENTION

An objective of the current invention is to provide a vehicle speed control device. The vehicle speed control device is used for remotely controlling the speed of a vehicle. The vehicle speed control device has a receiver device coupled to the vehicle that receives a speed control signal. A processor device is coupled to the receiver device and to a computer control system of the vehicle. The processor device receives the speed control signal from the receiver and sends a signal to the computer control system of the vehicle to control the speed of the vehicle.

### BRIEF DESCRIPTION OF THE DRAWINGS

FIG. 1 is a schematic of the vehicle speed control device.

### DETAILED DESCRIPTION OF THE PREFERRED EMBODIMENT

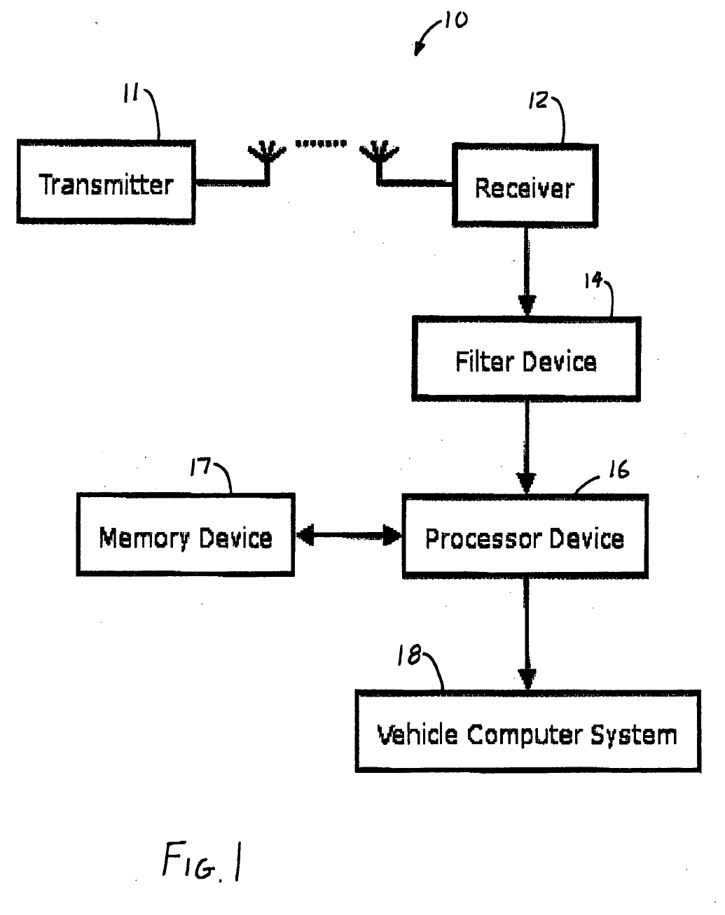

As shown in FIG. 1 for purposes of illustration, the present invention is concerned with a vehicle speed control device, generally designated in the accompanying drawings by the reference number 10.

Vehicle speed control device 10 comprises receiver 12. Receiver 12 receives a wireless signal from a third party transmitting device 11. In the preferred embodiment, third party signal is a laser signal. However, an embodiment of speed control device 10 could be developed that uses a different wireless signal such as radio signal. Receiver 12 sends any signal it receives to filter device 14.

Filter device 14 determines whether the signal received from receiver 12 is valid. A valid signal may be a laser signal that operates on a particular frequency or that contains a series of pulses that describe a particular code. Another valid signal may be a radio signal that operates on a particular frequency or a radio signal that is modulated to describe a particular code. If the signal is valid, filter device 14 allows the signal to pass to processor device 16.

Processor device 16 can control the vehicle's maximum speed if it receives a valid speed control signal from filter device 14. Processor device 16 is coupled to memory device 17. Processor device 16 uses memory device 17 to keep a record of how many speed control signals processor device 16 has received. Processor device 16 records this information so it can allow the vehicle's maximum speed to be gradually diminished. For example, processor device 14 may, upon receiving the first speed control signal, only limit the vehicle to 65 mph. On a second signal, processor device 14 may limit the vehicle to 35 mph. Finally, on a third signal, processor device 14 may stop the vehicle completely. Of course, an embodiment of speed control device 10 could be created that uses a different combination of speed control signals and limiting speeds. For example, each speed control signal may lower the vehicle's maximum speed by 10 mph. In short, processor device 14 could be programmed to handle any combination of speed control signals and vehicle maximum speeds. It should also be noted that an embodiment of vehicle speed control device 10 could be constructed that recognizes multiple different speed control signals where the different speed control signals instruct vehicle speed control device 10 to limit the vehicle's speed to a specific value. Processor device 16 controls vehicle maximum speed by sending signals to vehicle computer system 18.

Vehicle computer system 18 is a device that is coupled to the vehicle and can control the maximum speed of the vehicle. For example, the On Board Diagnostic II (OBD II) system that is currently deployed on many vehicles is capable of controlling a vehicle's speed. On a vehicle that has an OBD II system, processor device 16 could be coupled directly to the OBD II system in order to control the vehicle's maximum speed. However, as new vehicles are released, different vehicle computer systems 18 may be developed. It should be noted that vehicle speed control device 10 could be designed to couple processor device 16 to any new vehicle computer system 18 that is developed. Additionally, if a vehicle computer system 18 is unavailable, vehicle speed control device 10 could be designed to couple directly with a vehicle's fuel injection system to limit the vehicle's maximum speed. It should be obvious that any electronic method for controlling a vehicle's speed would be sufficient for use by processor device 16 and vehicle speed control device 10.

While the invention has been particularly shown and described with reference to preferred embodiments thereof, it will be understood by those skilled in the art that the foregoing and other changes in form and details may be made therein without departing from the spirit and scope of the invention.

I claim:

1. A vehicle speed control device for remotely controlling the speed of a vehicle comprising:
a receiver device coupled to the vehicle that receives a speed control signal; and
a processor device coupled to said receiver device and to a computer control system of the vehicle, said processor device receiving said speed control signal from said receiver and sending a signal to said computer control system of the vehicle to control the speed of the vehicle.

2. The vehicle speed control device of claim 1 further comprising a filter device coupled to said receiver device and to said processor device, said filter device determining whether said speed control signal substantially matches a determined speed control signal.

3. The vehicle speed control device of claim 1 wherein the computer control system of the vehicle comprises an On-Board Diagnostic II system.

4. The vehicle speed control device of claim 1 further comprising a memory device coupled to said processor device, said memory device for storing vehicle speed control device use data.

5. The vehicle speed control device of claim 1 wherein said processor device retrieves data from said memory device modifying processor device output based on prior use of said vehicle speed control device.
